(19) United States
(12) Patent Application Publication
(10) Pub. No.: US 2010/0088373 A1
(43) Pub. Date: Apr. 8, 2010

(54) Method of Tracking & Targeting Internet Payloads based on Time Spent Actively Viewing

(76) Inventor: Jeremy Pinkham, Ellicott City, MD (US)

Correspondence Address: KILPATRICK STOCKTON LLP, 1001 WEST FOURTH STREET, WINSTON-SALEM, NC, 27101, US

(21) Appl. No.: 12/393,546

(22) Filed: Feb. 26, 2009

Related U.S. Application Data
(60) Provisional application No. 61/195,406, filed on Oct. 6, 2008.

(51) Int. Cl. G06F 15/16; G06F 15/173; G06Q 30/00

(52) U.S. Cl. 709/204; 709/224; 705/14.55; 705/14.53

(57) ABSTRACT

A system for tracking exposure time of a payload rendered on a user computer is provided. The system provides a website rendered on the user computer. Payload is rendered on the user computer in response to a request by data associated with the rendered website. The system tracks whether the payload is visually engaged by a user operating the user computer.

### RELATED APPLICATIONS

This application claims domestic priority under 35 U.S.C. 119(e) to U.S. Provisional Patent Application Ser. No. 61/195,406, filed on Oct. 6, 2008, which is incorporated herein by reference.

### BACKGROUND OF THE INVENTION

1. Field of the Invention

The present inventions enable the tracking, reporting, and targeting of any Internet payload or webpage content such as Internet advertising based on the amount of time any individual user spends actively viewing such payload. The invention can be applied to any Internet payload but will be described in the context of Internet advertising.

2. Description of the Prior Art

Internet advertising campaigns generate an event called an “impression”, which is simply the display of a particular advertisement to a particular user in a web browser. Every time an advertisement is shown to a user it is recorded as an impression. If the user responds to an advertisement by clicking on it, then it generates another event called a “click”. If the user completes the activity that the advertisement was attempting to induce, then it generates yet another event called a “conversion”. The number of impressions, clicks, and conversions, either individually or in any combination, are used for reporting, analytic, and billing purposes.

In addition, Internet advertising campaigns are often executed in such a way as to limit the number of impressions any single user will see within a given timeframe. For example, an Internet advertising campaign may be executed such that no one user is shown more than 7 impressions for that campaign in any one 24 hour period. This is referred to as frequency capping, and is a standard practice in Internet advertising. Frequency capping is applied to Internet advertising campaigns for various reasons, including performance efficiency and brand management.

Although heavily employed in the Internet advertising industry, frequency capping as defined above has significant drawbacks. First, it only takes into account the number of times an advertisement was rendered by a user's browser, regardless of whether the advertisement was actively viewed by the user. This creates a related drawback when analyzing statistics for the campaign, as every impression is weighted evenly. Second, although its intention is to limit the possibility of overexposure of a particular campaign, it can have the opposite effect by creating under-exposure if the frequency cap does not take all necessary factors into account.

The invention presented here addresses these drawbacks by creating a new methodology for “capping” Internet advertising campaigns, and a new metric for analyzing such campaigns. The new methodology and metric both revolve around “time spent” viewing an advertisement on the Internet as opposed to the number of times an advertisement is rendered.

The innovations in this invention are the application of client side time tracking combined with server side processing to limit the exposure of particular Internet payloads (e.g. advertisements), as well as provide the new metrics associated with the time tracking.

### SUMMARY OF THE INVENTION

This invention provides a new methodology to limit the exposure of an Internet advertising campaign as well as new metrics for analyzing these campaigns. The new methodology employs time tracking technology to allow the execution of an Internet advertising campaign such that it is not displayed to any individual user for longer than a specific amount of time in a given timeframe. For example, a campaign may be executed that no one user is shown the campaign for more than 30 minutes in a 7 day period. Furthermore, the time tracking technology provides the ability to only register time as “actively viewing” if the following criteria are met:

1. A certain percentage of the actual advertisement unit is visible in the users browser window, and

2. The user is interacting with their web browser.

The new metrics for analyzing campaigns based on this technology are “average time per user”, “total time exposed”, “time to click”, and “time to conversion”, which are defined as follows:

1. Total Time Exposed—the total amount of time that a particular advertisement was displayed.

2. Average Time Per User—The average amount of time a particular advertisement was shown to individual users over a specified timeframe.

3. Time To Click—The average amount of time an advertisement was actively displayed to a user before they clicked on the ad.

4. Time To Convert—The average amount of time an advertisement was actively displayed to a user before they took the action that the advertisement was attempting to induce.

### BRIEF DESCRIPTION OF THE FIGURES

It is to be understood that the following drawings depict details of only typical embodiments of the invention and are not therefore to be considered to be limiting of its scope, and in particular:

FIG. 1 illustrates a webpage and an item being tracked for exposure;

FIG. 2 illustrates the operation of the present inventions and the operation of the time tracker in an asynchronous manner;

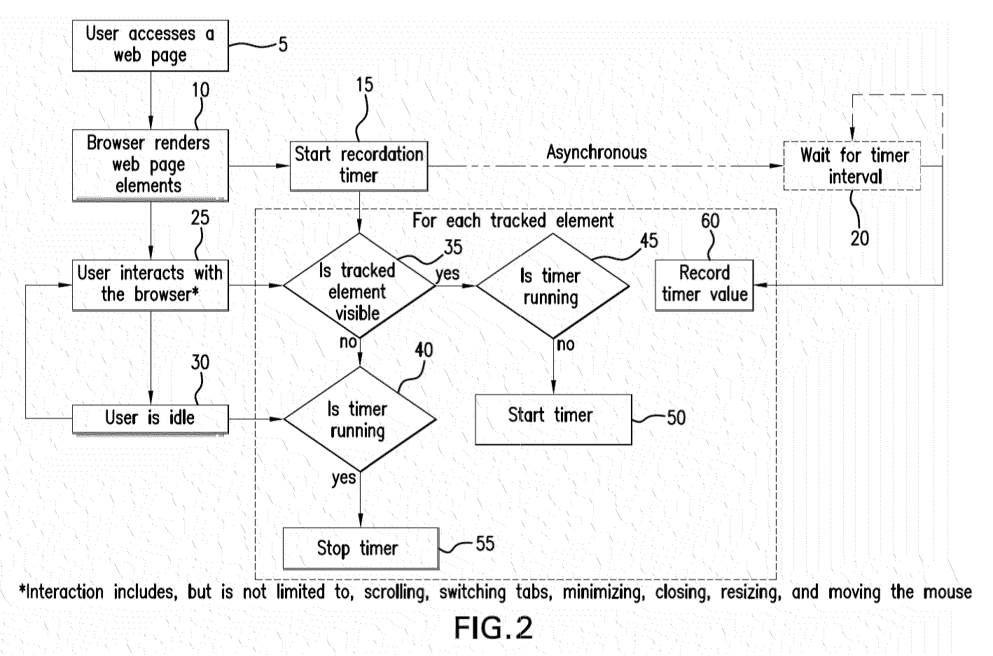

FIG. 3 illustrates the operation of the present inventions and the operation of the time tracker on a network, such as the Internet 100;

FIG. 4 illustrates the operation of the present inventions and the operation of a time tracker in an synchronous manner; and

FIG. 5 illustrates the operation of the present inventions and the creation and delivery of the time tracker.

### DETAILED DESCRIPTION OF THE INVENTION

“Display capping” refers to limiting the time and frequency at which a user may be exposed to a given advertisement in a given period of time. The inventive tracking system provides for advertisement exposure tracking which includes both reporting and advertisement display capping functionality driven by the amount of time an advertisement is actively visible to a user. To accomplish this feature, the system keeps track of how long the user is actually active in a browser while an advertisement is visible, as will be explained.

In order to be considered actively viewing an advertisement, the user must be interacting with the browser in some way, for example by scrolling, clicking, or typing. If the user switches browser tabs, switches to a different desktop application, or simply does not interact with the browser, then the system switches to an idle mode and time does not accumulate.

Similarly, advertisements are only considered visible if they are actually displayed in the viewable portion of the webpage. For example, if the advertisement is below the fold (i.e., the lowest viewable portion of a monitor) then it is not considered visible and thus time will not accumulate for that advertisement until it becomes visible.

Exposure tracking is performed with HTML tags using Javascript (hereinafter “Javascript tags”). According to the invention, tracking is performed by the integration of typical advertisement elements with a tracking tag. The tracking tag is present on the main webpage of all partner webpages. A “partner webpage” represents various organizations agreeing to display each other's content.

The tracking tag contains all of the logic necessary to track time and determine if a tracked advertisement is visible. The programming of the tracking tag would be readily understood to one of ordinary skill in the art after reading the immediate specification. The advertisement simply registers itself with a component of the tracking tag to initiate tracking.

There are a myriad of scenarios under which registration with the tracking tag by an advertisement should occur. However, the following three permutations generally exist:

1. The advertisement is called upon from an advertiser's website using a Javascript tag (hereinafter an “advertisement-requesting tag”), which instructs the advertisement to be rendered inline, that is, content within the main webpage. An illustration of this occurrence is when, for example, a business's advertisement appears within the same frame as the partner's main website

2. The advertisement-requesting tag instructs the advertisement to be displayed within an iframe with an origin internet domain that is different than the containing webpage (i.e., the webpage containing the advertisement). An illustration of this occurrence is when, for example, a business's advertisement appears within an iframe disposed on an unrelated news-media's website.

3. The advertisement-requesting tag instructs the advertisement to be displayed within an iframe with an origin domain that is the same as the containing page. This scenario most often occurs when a partner uses inline Javascript tags within the partner's own advertisement frame. An illustration of this occurrence is when, for example, a partner includes an advertisement within an iframe disposed on the partner's website.

In all of these scenarios, an exposure tracking component within the tracking tag must be able to determine the state of the user and the visibility of the advertisement on the webpage. The details on each of these scenarios are presented below.

### Scenarios

1. Inline Javascript

When advertisements are rendered inline via Javascript tags, the advertisement and an advertisement-response tag, contemporaneously provided by the advertiser with the advertisement, reside in the same security context as the tracking tag disposed on the website, and thus the advertisement-response tag and the tracking tag can communicate directly via JavaScript. The information communicated by the advertisement-response tag to the tracking tag includes the fact that the advertisement has been rendered on the computer and the location of the advertisement on the display. In this scenario, the response from the advertisement includes a named div that contains the actual advertisement element. Upon rendering, the advertisement-response tag notifies the tracking tag to track that div.

2. Iframe—Same Domain

As with inline JavaScript, using an iframe on the same domain as the main webpage results in the advertisement, the advertisement-response tag, and the tracking tag residing in the same security context. As a result, the advertisement-response tag can communicate directly with the tracking tag to initiate tracking.

3. Iframe—Different Domain

When an advertisement is instructed to be rendered on an iframe which is on a different domain than it's containing webpage, the resulting iframe resides in a different security context than the main webpage because of JavaScript security rules. In other words, it is considered a 3rd party object. As a result, it cannot directly communicate with the tracking tag to initiate tracking.

Furthermore, the tracking tag on the main webpage does not have access to the 3rd party components within the iframe. The tracking tag does, however, have access to components within the advertisement iframe that utilize the same domain as the main page. Accordingly, in response to the advertisement request by the advertisement-requesting tag, there is provided another “nested” iframe within the 3rd party iframe. The nested iframe contains the advertisement-response tag and resolves to a file on the same domain as-the main page. That is, as part of the URI for this nested iframe, the advertisement response will include information necessary for the exposure tracking logic (e.g. information identifying the impression being tracked). Note, in order to make heavy use of browser caching for this nested iframe, the exposure tracking information is included after the ‘#’ in the URI . . . thus it is not considered for cache evaluation.

After the tracking tag is loaded onto the main webpage, by virtue of JavaScript present in the code of the page, the tracking tag will check 3rd party iframes present on the webpage for the presence of this nested iframe to which it has access. If the nested iframe is present, then the tracking tag will initiate exposure tracking for the 3rd party iframe element.

### Exposure Determination

The time tracking libraries use geometric calculations to determine if a tracked item is visible by comparing the size and positioning of the visible portion of a webpage (referred to as the viewport) to the size, location, and position of the element being tracked. Each tracked item defines its own criteria for what percentage of the item must be visible for it to be considered “exposed”.

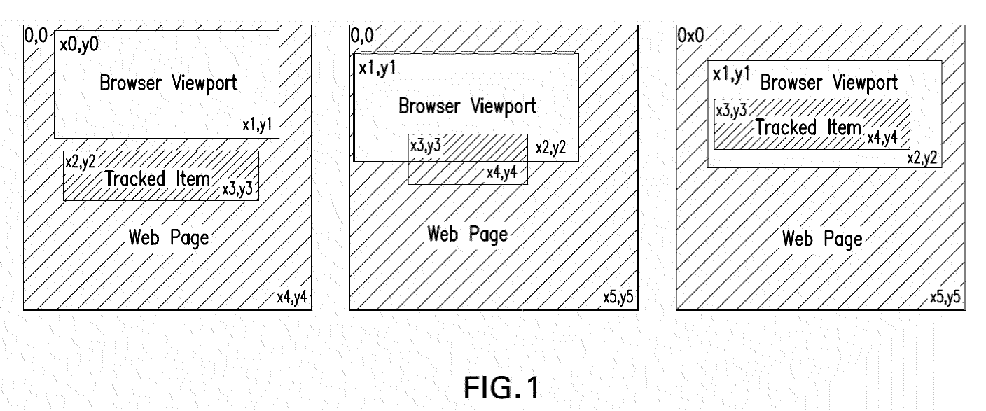

For example, FIG. 1 shows a webpage and an item being tracked for exposure in three different states, one without any exposure of the tracked item, one with partial exposure, and one with full exposure. The time tracking libraries can algorithmically determine the state using the values of x1 through x5 and y1 through y5 to calculate the size of the area of overlap of the viewport and the tracked item.

### Active Determination

The above exposure determination mechanism is combined with a determination of user activity to fully assess whether time should accumulate for the tracked item. Users are considered active if they have not been idle for more than N seconds, where N is customized for each tracked item, and the browser viewport is the active window on their computer. In order to not be considered idle, the user must be moving the mouse, scrolling the mouse scroll wheel, or using the keyboard while the browser viewport is the active window on their computer.

The present inventions and time tracker consists of several components.

Payload Being Tracked—The Payload is the item on a webpage for which time exposure is being tracked. This will typically be an advertisement, but that is not a requirement. In order to illustrate the present inventions, however, the remaining part of this description will refer to an advertisement as an example of a Payload that is delivered with a web page.

Time Tracker—The Time Tracker is a separate piece of JavaScript that is delivered along with, or separate from, an advertisement. The Time Tracker will periodically update a time tracker cookie in a user's browser with the amount of time the advertisement has been actively exposed and with other data. The Time Tracker uses various JavaScript functionality and geometric calculations to determine if the payload is “actively displayed”.

Time Receiver—The Time Receiver is located in a server separate from the user's computer. The Time Receiver receives the time slices from the browser and sends them to the analysis engine (described below). In other words, the Time Receiver receives data from the tracker cookies or receives tracker cookies and extracts data from those cookies. The Time Receiver sends the data to a database for storage, to an analysis engine for analysis and to a time limiter (described below).

Analysis Engine—The Analysis Engine is located in a server separate from the user's computer. The Analysis Engine processes the data or individual time slices into the various metrics described in the Summary section above. It analyzes the time tracker cookie data itself and/or in conjunction with other time tracker and advertising data in the database. The analyses performed by the analysis engine are, for example, aggregating data for a user, aggregating data for across users, performing statistical analyses of the data.

Time Limiter—The Time Limiter is located in a server separate from the user's computer. The Time Limiter contains information regarding what advertisements should be shown to specific types of users. The Time Limiter is part of the serving schedule and decision engine or campaign manager and is responsible for determining if a particular advertisement is or is not eligible to be displayed to a user based on the cumulative amount of time is has already been actively displayed combined with the configured limitations of the payload. For example, an advertiser may want its advertisement to be shown to users aged 18-25 for five minutes each day. Thus, the Time Limiter will examine the data from a user to determine whether that goal was achieved. If not, then the Time Limiter may continue to show the specified advertisement to the user. If yes, then the Time Limiter may stop showing that user the specified advertisement.

FIG. 1 illustrates the operation of the present inventions and the operation of the time tracker in an asynchronous manner.

The flow chart begins at Step 5 with a user accessing a web page.

At Step 10, the user's browser renders the elements of the webpage and at least one of the elements has a time tracker associated with the element.

Next, the time tracker performs several steps. First, at Step 15, the time tracker starts a recordation timer and, at Step 20, the time tracker starts an interval timer.

Second, the time tracker waits for the user to interact with the browser, Step 25, or to be idle, Step 30. Each of those steps triggers different steps in the time tracker. “Interacting” can be defined to be any type of interaction with the browser and can include, for example, scrolling, switching tabs, minimizing, closing, resizing and moving the mouse. The web browser sends to the time tracker activity reports. If the time tracker has not received an activity report when it performs Step 25, then the time tracker can infer the user is not active, i.e., the user is idle, and goes to Step 30.

If, at Step 25, the user is interacting with the browser, then the time tracker goes to Step 35. Otherwise, the user is idle and the time tracker goes to Step 30.

If, at Step 30, the user is idle, then the time tracker returns to Step 25 to determine if the user is interacting with the browser and also goes to Step 40.

Steps 15 and 25 go to Step 35 at which point the time tracker determines whether the element associated with the time tracker is visible to the user and not hidden from the user's eyesight. Using JavaScript functionality and geometric calculations, the time tracker is programmed to determine whether the advertisement is visible. For example, the time tracker can determine: (i) whether the advertisement is in the viewing area of the browser and is not out of the viewing area such as when a user scrolls down or up a webpage that contains the advertisement, (ii) whether the browser is minimized and (iii) whether the webpage and advertisement are in a Tab in the browser that is not viewable, i.e., it is behind other Tabs or other viewable content, such as a word processor or other software package active on the computer.

If, at Step 35, the element is visible, then, at Step 45, the time tracker determines whether the recordation timer is running. If not, then, at Step 50, the time tracker starts the recordation timer.

If, at Step 35, the element is not visible, then, at Step 40, the time tracker determines whether the recordation timer is running. If yes, then, at Step 45, the time tracker stops the recordation timer.

As the interval timer counts upward and reaches pre-selected intervals, e.g., every one second, then, at Step 60, the time tracker writes to a cookie the value of the recordation timer as well as other data associated with the time tracker and associated element.

The processes shown in FIG. 1 are explained in more detail below in connection with the other Figures.

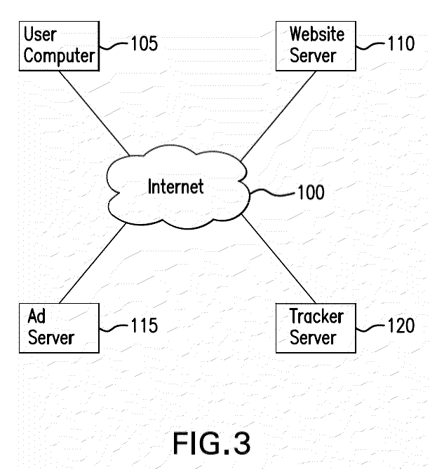

FIG. 3 illustrates the operation of the present inventions and the operation of the time tracker on a network, such as the Internet 100. The various servers described below can be located in the same computer or in different computers on a network such as an intranet or the Internet.

A user on a user computer 105 uses a web browser to access Internet websites and web webpages from web servers such as web server 110.

In response to certain requests from the user computer 105, the web server 110 will return a webpage that includes one or more advertisements and one or more time trackers.

Web server 110 can obtain the advertisements from an advertisement server 115, which may be located with web server 110 or in a separate location accessible via the Internet.

Web server 110 can obtain time trackers from a tracker server 120, which may be located with web server 110, advertisement sever 115 or in a separate location accessible via an intranet or the Internet.

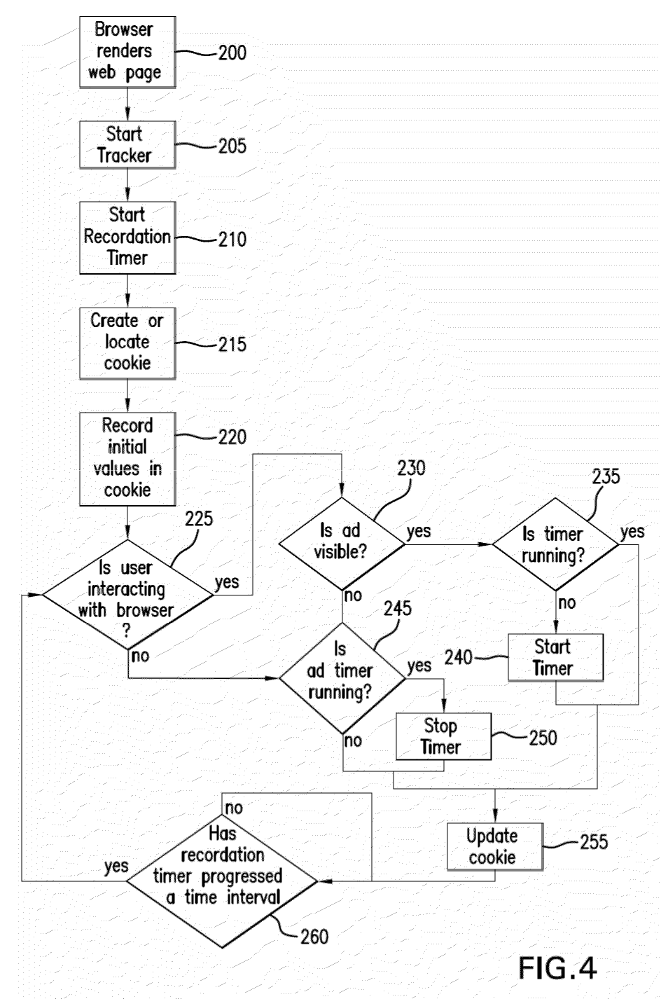

FIG. 4 illustrates the operation of the present inventions and the operation of a time tracker in an synchronous manner. The time tracker's goals are to determine whether an advertisement delivered to the user's web browser is visible to the user and whether the user is interacting with the browser and, thus, viewing the advertisement. The time tracker will track various parameters (e.g., how long an advertisement is visible, how long a user interacts with the browser) and store data regarding those parameters in a cookie on the user's computer.

At Step 200, a browser on the user computer renders a webpage that includes an advertisement and a time tracker.

At Step 205, the time tracker starts.

At Step 210, a recordation timer and an interval timer start. The recordation timer is used to time how long the advertisement is Visible (as described below) to the user. The interval timer is used to run the time tracker at pre-selected time intervals, e.g., every second.

At Step 215, the time tracker creates a time tracker cookie on the user computer or, if a cookie already exists on the computer, the time tracker locates the time tracker cookie.

At Step 220, the time tracker records in the time tracker cookie initial data regarding pre-selected parameters such as data about the user and advertisement.

At Step 225, the time tracker determines whether the user is interacting with the browser on the user computer. “Interacting” can be defined to by any type of interaction with the browser and can include, for example, scrolling, switching tabs, minimizing, closing, resizing and moving the mouse. The web browser sends to the time tracker activity reports. If the time tracker has not received an activity report when it performs Step 225, then the time tracker can infer the user is not active, i.e., the user is idle.

If the answer to the question at Step 225 is yes, then, at Step 230, the time tracker determines whether the advertisement is Visible to the user and not hidden from the user's eyesight. Using JavaScript functionality and geometric calculations, the time tracker is programmed to determine whether the advertisement is Visible. For example, the time tracker can determine: (i) whether the advertisement is in the viewing area of the browser and is not out of the viewing area such as when a user scrolls down or up a webpage that contains the advertisement, (ii) whether the browser is minimized and (iii) whether the webpage and advertisement are in a Tab in the browser that is not viewable, i.e., it is behind other Tabs.

If the answer to the question at Step 230 is yes, then, at Step 235, the time tracker determines whether the recordation timer is on. If the answer to the question at Step 235 is no, then, at Step 240, the time tracker activates the recordation timer.

If, at Step 230, the advertisement is not Visible, then, at Step 245, the time tracker determines whether the recordation timer is on. If yes, then, at Step 250, the time tracker stops the recordation timer.

After Steps 235, 240, 245 and 250, the time tracker goes to Step 255, at which point, the time tracker updates the time tracker cookie with information data regarding the pre-selected parameters, such as data regarding the Visibility of the advertisement.

Next, the time tracker goes to Step 260. At that step, the time tracker determines whether the interval time has progressed a pre-selected time interval, e.g., one second. If yes, then the time tracker returns to Step 225. If no, then Step 260 repeats itself until the pre-selected time interval is reached.

The time tracker logic continues until the browser window containing the advertisement is closed or the user navigates to a different webpage in the browser window containing the advertisement.

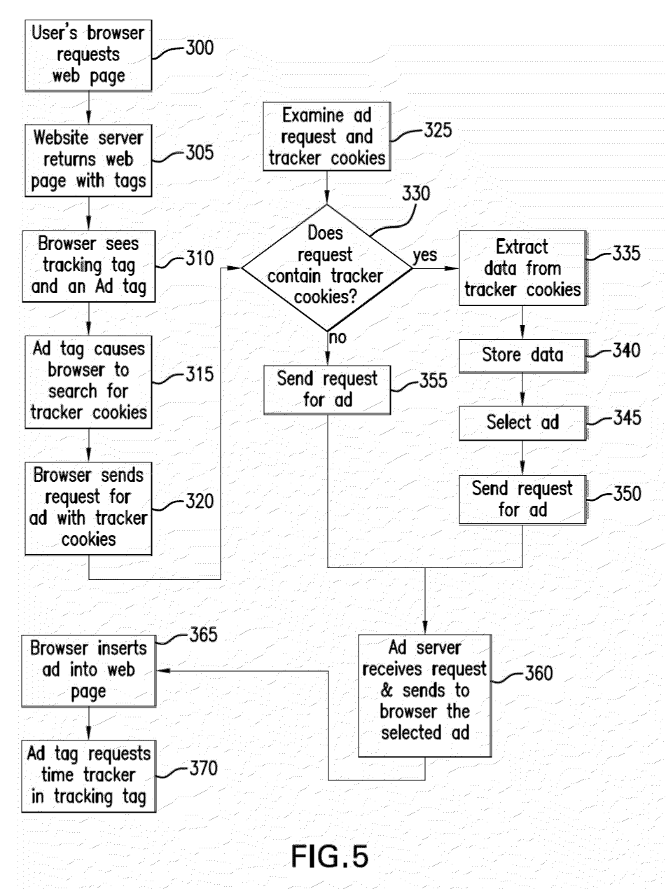

FIG. 5 illustrates the operation of the present inventions and the creation and delivery of the time tracker. The steps described below can be performed by the servers depicted in FIG. 3 working together or by a single server that performs all of the functions of the servers in FIG. 3.

At Step 300, a user on a user computer uses an Internet browser to send to a website server via the Internet a request for a web page.

At Step 305, the website server examines the request and returns the requested webpage with tags. As indicated, tags are programs (e.g., Javascript functionality or geometric calculations) that can run on the user's computer when the user's browser renders the web page.

At Step 310, the user's browser renders the webpage and sees at least a tracking tag, an advertisement-requesting tag and a space for an advertisement.

At Step 315, the advertisement-requesting tag causes the browser to search for time tracker cookies on the user's computer.

At Step 320, advertisement-requesting tag associated with the space for the advertisement causes the browser to send a request for an advertisement that includes any collected tracker cookies.

At Step 325, the tracker server receives and examines the request.

At Step 330, the tracker server determines whether the request contains tracker cookies that the tracker server can use.

If, at Step 330, the tracker server locates such time tracker cookies, then, at Step 335, the tracker server extracts the data from the time tracker cookies.

At Step 340, the tracker server stores in a database the extracted data. The database contains all data that the tracker server has collected from users that have received time trackers and other data regarding advertisements.

At Step 345, the tracker server examines the data and, based on the data, selects an advertisement to be delivered to the user's browser in response to the request for an advertisement.

At Step 350, the tracker server sends to an advertisement server a request for the advertisement server to send to the user's browser the selected advertisement.

If, at Step 330, the request does not contain tracker cookies that the tracker server can use, then at Step 355, the tracker server selects an advertisement to be delivered to the user's browser in response to the request for an advertisement. The tracker server can select an advertisement based on, for example, the user and/or accumulated data stored in a database regarding users and advertisements. Note, the advertisement can be selected in many other conventional manners. For example, the tracker server can send to an advertisement server a request for the advertisement server to select an advertisement, and the advertisement server can select the advertisement based on any criteria or on pre-selected criteria set by the advertisement server operator.

At Step 360, the advertisement server receives from the tracker server a request to send to the user's browser a selected advertisement, after which, the advertisement sever sends the selected advertisement.

At Step 365, the user's browser receives and inserts into the webpage in the browser the selected advertisement.

At Step 370, the advertisement-response tag calls the tracking tag to start a time tracker program in the tracking tag for the selected advertisement.

The process shown in FIG. 5 occurs for every advertisement on a webpage that has an advertisement-requesting tag. When an advertisement is inserted into the web page, each advertisement-response tag calls the tracking tag to start a time tracker program for each inserted advertisement.

The present invention may be embodied in other specific forms without departing from its spirit or essential characteristics. The described embodiments are to be considered in all respects only as illustrative and not as restrictive. The scope of the invention is, therefore, indicated by the appended claims and their combination in whole or in part rather than by the foregoing description. All changes that come within the meaning and range of equivalency of the claims are to be embraced within their scope.

We claim:

1. A system for tracking exposure time of a payload rendered on a user computer, said system comprising:
a website rendered on the user computer;
payload rendered on the user computer in response to a request by data associated with said rendered website; and
tracking means in communication with data associated with said payload for tracking whether said payload is visually engaged by a user operating the user computer.

2. The system of claim 1 wherein:
said data associated with said rendered website is a payload-requesting tag disposed on said website;
said data associated with said payload is a payload-response tag, which is rendered on the user computer in response the request for payload; and
said tracking means communicates with said payload-response tag for tracking whether said payload is visually engaged by the user operating the user computer.

3. The system of claim 2 wherein said payload-response tag is provided in a same security context as the website.

4. The system of claim 3 wherein said tracking means includes a tracking tag disposed on said website.

5. The system of claim 4 wherein the payload and payload-response tag are rendered inline with the website.

6. The system of claim 4 wherein the payload and payload-response tag are rendered in an iframe disposed on the website, the iframe being in a same domain as the website.

7. The system of claim 4 wherein the payload is disposed in an iframe disposed on the website, the payload iframe being on a different domain than the website.

8. The system of claim 7 including a secondary iframe nested within the payload iframe, the secondary iframe being on a same domain as the website and containing the payload-response tag.

9. The system of claim 1 wherein said payload is an advertisement.

10. The system of claim 4 wherein said tracking tag is provided in Javascript.

11. The system of claim 4 wherein said tracking tag communicates with a tracking cookie disposed on the user computer.

12. The system of claim 1 wherein said tracking means determines the location of the rendered payload with respect to the viewable portion of the monitor and other viewable content rendered on the user computer.

13. The system of claim 1 wherein said tracking means determines whether the user should have access to the payload.

14. The system of claim 13 where the tacking means determines a payload exposure time period within which the user has visual exposure to the payload, the tracking means determining whether to continue the user's access to the payload based on the payload exposure time period.

15. The system of claim 13 where the tracking means determines whether to grant the user access to the payload based on characteristics of the user.

16. The system of claim 15 wherein the characteristics of the user include one or more of age and sex of the user.

17. The system of claim 13 wherein the tracking means determines whether the user is interacting with a browser on which the payload is rendered, and the tracking means discontinues computing user exposure time if it is determined that the user is not interacting with the browser.

18. The system of claim 17 wherein the time tracking means determines whether the user is engaging means for interacting with the browser.

19. The system of claim 18 wherein said means for interacting with the browser is a keyboard and/or a mouse.

20. The system of claim 11 wherein the tracking cookie is deposited on the user computer responsive to the user interacting with the website.

21. The system of claim 20 wherein the tracking server receives data from the user computer via the tracking tag communicating with the tracking cookie, the tracking server requests the payload server to forward payload to the user computer based on the received data.

22. The system of claim 21 wherein data analyzed by the tracking tag includes one or more of: the location of the rendered payload; the payload exposure time period; the characteristics of the user; and whether the user is interacting with the browser.
